(19) United States
(12) Patent Application Publication
(10) Pub. No.: US 2024/0416330 A1
(43) Pub. Date: Dec. 19, 2024

(54) ZEOLITE BETA PARTICLES WITH CENTER-RADIAL CONFIGURED MESOPORES AND METHODS OF MAKING THE SAME

(71) Applicants: Saudi Arabian Oil Company, Dhahran (SA); King Abdullah University of Science and Technology, Thuwal (SA)

(72) Inventors: Rajesh Kumar Parsapur, Thuwal (SA); Robert Peter Hodgkins, Dhahran (SA); Omer Refa Koseoglu, Dhahran (SA); Kuo-Wei Huang, Thuwal (SA); Anissa Bendjeriou Sedjerari, Thuwal (SA)

(73) Assignees: Saudi Arabian Oil Company, Dhahran (SA); King Abdullah University of Science and Technology, Thuwal (SA)

(21) Appl. No.: 18/336,625

(22) Filed: Jun. 16, 2023

(51) Int. Cl. B01J 29/70; B01J 6/00; B01J 35/10; B01J 37/00; B01J 37/02; C01B 39/04

(52) U.S. Cl. CPC B01J 29/7007; B01J 6/001; B01J 35/617; B01J 35/618; B01J 35/633; B01J 35/635; B01J 35/643; B01J 35/647; B01J 37/0018; B01J 37/0236; C01B 39/04

(57) ABSTRACT

Described herein are zeolite Beta particles with radially arranged mesopores and methods of making the same. In one or more embodiments, a zeolite Beta particle may include a Beta zeolitic framework including a plurality of micropores having diameters of less than or equal to 2 nm. In embodiments, the Beta zeolitic framework may include alumina and silica. In embodiments, the zeolite Beta particles disclosed herein may include a plurality of mesopores having diameters of greater than 2 nm and less than or equal to 50 nm. In embodiments, the plurality of mesopores may be arranged in a center-radial configuration, such that mesopores run from a central region of the zeolite Beta particle towards the edge of the zeolite Beta particle.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or Beta.

### SUMMARY

In light of the aforementioned uses for zeolites, new zeolite compositions and methods of making the same are of interest. Embodiments of the present disclosure are directed to zeolite materials and processes for making such materials. Specifically, embodiments disclosed herein relate to zeolite Beta particles with radially arranged mesopores. Beta zeolites, such as these, having radially arranged mesopores, according to one or more embodiments, may offer enhanced diffusion of reactant species to the active sites present in the interior of the Beta zeolite particle. Such features may lead to improved catalytic performance when used, for example, in reactions such as cracking.

According to one or more embodiments disclosed herein, a zeolite Beta particle may comprise a Beta zeolitic framework comprising a plurality of micropores having diameters of less than or equal to 2 nm. In embodiments, the Beta zeolitic framework may comprise alumina and silica. In embodiments, the zeolite Beta particles disclosed herein may have a plurality of mesopores with diameters of greater than 2 nm and less than or equal to 50 nm. In embodiments, the plurality of mesopores may be arranged in a center-radial configuration, such that mesopores run from a central region of the zeolite Beta particle towards the edge of the zeolite Beta particle.

According to one or more additional embodiments, a method of making a zeolite Beta particle comprising a plurality of mesopores arranged in a center-radial configuration may comprise dissolving a parent zeolite in a basic solution to yield a basic zeolite solution, wherein the parent zeolite comprises micropores defined by a *BEA microporous framework; adding to the basic zeolite solution a supramolecular templating agent and an ionic co-solute to form a supramolecular templating agent/co-solute/zeolite mixture; hydrothermally treating the supramolecular templating agent/co-solute/zeolite mixture for a duration of time to form a hydrothermally treated supramolecular templating agent/co-solute/zeolite mixture; separating a solid zeolitic product from the hydrothermally treated supramolecular templating agent/co-solute/zeolite mixture, wherein the solid zeolitic product comprises a plurality of mesopores arranged in a center-radial configuration and wherein the plurality of mesopores comprise the supramolecular templating agent; and removing the supramolecular templating agent from the solid zeolitic product to yield a zeolite Beta particle comprising mesopores arranged in a center-radial configuration.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a flow chart depicting the synthesis of zeolite Beta particles with a plurality of radially arranged mesopores, according to one or more embodiments of the present disclosure;

FIG. 2A depicts a Transmission Electron Microscopy (“TEM”) image of zeolite Beta particles with a plurality of radially arranged mesopores, according to one or more embodiments of the present disclosure; and

FIG. 2B depicts a TEM image of a single zeolite Beta particle with a plurality of radially arranged mesopores, according to one or more embodiments of the present disclosure.

FIG. 3 depicts a TEM image of a comparative zeolite Beta particle with a plurality of mesopores that are not arranged radially, but rather arranged with long-range mesoporous order having cubic symmetry.

FIGS. 4A-4C depict TEM images of a comparative zeolite Beta particle that does not include a plurality of mesopores.

FIG. 5 depicts N₂ physisorption isotherms of (a) zeolite Beta particles (with no mesopores) and (b) zeolite Beta particles with a plurality of radially arranged mesopores, according to one or more embodiments of the present disclosure;

FIG. 6A depicts the low angle X-Ray Diffraction (“XRD”) patterns of (a) zeolite Beta particles (with no mesopores) and (b) zeolite Beta particles with a plurality of radially arranged mesopores, according to one or more embodiments of the present disclosure;

FIG. 6B depicts the high angle XRD patterns of (a) zeolite Beta particles (with no mesopores) and (b) zeolite Beta particles with a plurality of radially arranged mesopores, according to one or more embodiments of the present disclosure;

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

One or more embodiments presently described herein are directed to zeolite Beta particles with a plurality of radially arranged mesopores. As used throughout this disclosure, “zeolites” or “zeolite materials” generally refer to micropore-containing inorganic materials with regular intra-crystalline cavities and channels of molecular dimension. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein. The zeolite particles described presently, in one or more embodiments, may have a *BEA microporous framework type, which is the type present in zeolite Beta. The *BEA microporous framework has a three-dimensional network of 12-membered ring pores featuring an intergrowth of two or more polymorphs with pore diameters of 0.56 nm×0.56 nm and 0.66 nm×0.67 nm. In embodiments, the micropores of the zeolite Beta particles disclosed herein may have diameters of greater than or equal to 0.1 nm and less than or equal to 2 nm.

In embodiments, the zeolite Beta described herein may be shaped as particles that may be generally spherical or irregularly globular (that is, non-spherical). In embodiments, the particles disclosed herein have a “particle size” that may be measured as the greatest distance between two points located on a single zeolite particle. For instance, the particle size of a spherical particle would be its diameter. In other shapes, the particle size may be measured as the distance between the two most distant points of the same particle, wherein these points may lie on outer surfaces of the particle.

Particle size may be determined by, for instance, visual examination under a microscope, or by dynamic light scattering (“DLS”) whereby the hydrodynamic radius is obtained. The particle size may be an average particle size. In embodiments, the particles disclosed herein may have an average particle size from 100 nm to 1000 nm, from 150 nm to 750 nm, or from 200 nm to 500 nm.

In one or more embodiments, the *BEA microporous framework of the zeolite Beta particles described herein may comprise alumina and silica, which is consistent with the materials included in a zeolite Beta, as is understood by those skilled in the art. The ratio of silica to alumina in zeolite Beta may vary. According to one or more embodiments described herein, the molar ratio of silica to alumina in the zeolite Beta may be from 10 to 10,000, such as from 10 to 5,000, from 10 to 1,000, from 10 to 500, from 10 to 100, from 10 to 80, from 50 to 10,000, 50 to 5,000, from 50 to 1,000, from 50 to 500, or from 50 to 100.

In one or more embodiments, the zeolite Beta particles disclosed herein may further comprise a plurality of mesopores having diameters of greater than or equal to 2 nm and less than or equal to 50 nm. In embodiments, the plurality of mesopores may be arranged in a “center-radial configuration.” As used herein, a center-radial configuration of mesopores means that at least a portion of mesopores run from a central region of the zeolite Beta particle toward the edge of the zeolite Beta particle. Generally, a “central region” of the zeolite Beta particle can be any interior portion of the zeolite Beta particle, but may be near or at the middle. As used herein, the descriptor “radially arranged mesopores” indicates a plurality of mesopores arranged in a center-radial configuration. In some embodiments, a portion of the mesopores may not be oriented in a center-radial configuration. However, in one or more embodiments, a majority of the mesopores by volume, such as at least 75%, at least 90%, at least 95%, or even at least 99% of the mesopores, may comprise a center-radial configuration, as described herein.

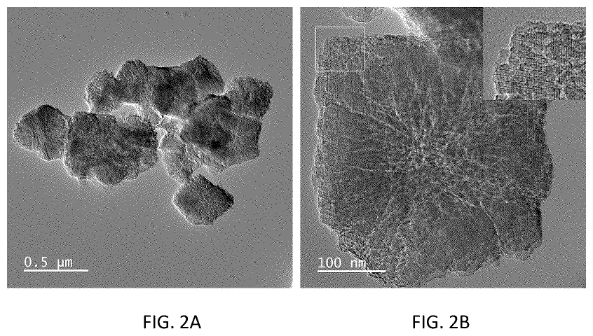

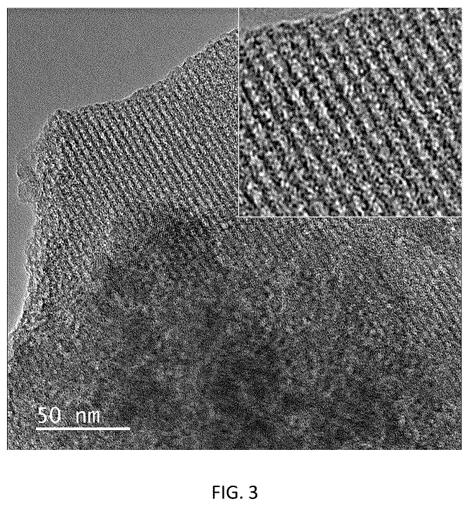

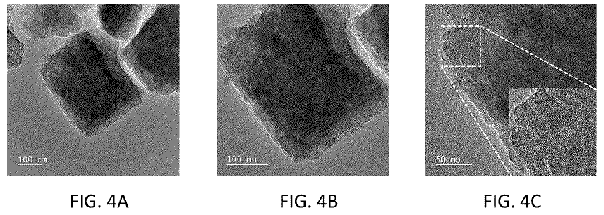

Generally, as is detailed in the Examples section that follows, the center-radial configuration of mesopores can be determined using microscopy, such as transmission electron microscopy (“TEM”). The center-radial configuration of the mesopores of the disclosed zeolite Beta particles may be observed by viewing the differences in electron density contrast in a TEM micrograph. FIG. 2B show center-radial configured mesopores. For comparison, FIGS. 3 and 4A-4C do not include center-radial arranged mesopores. The pores need not be all exactly radial, but generally show center-radial patterns as compared with conventional zeolites. Based on at least these examples, those skilled in the art can determine whether center-radial configuration is present based on visual inspection under microscopy.

In embodiments of the zeolites disclosed herein, the radially arranged mesopores may be interconnected in a three-dimensional reticular network by branches and sub-branches of mesopores and zeolitic micropores. Without being bound by any particular theory, it is believed that such a highly intricate network of mesopores and micropores may offer enhanced diffusion of reactant species to the active sites present in the interior of the zeolite Beta particle. In addition, unlike traditional mesoporous zeolites wherein axial mesopores open only at the two opposing ends of the zeolite particle, the radial mesopores of the zeolite Beta particles described herein open onto the external surface of the zeolite particle, which may allow for the development of novel catalytic systems and materials. Without being bound by any particular theory, it is believed that such accessibility at the surface of the zeolite particle may allow molecules such as, for instance, asphaltenes or hydrocarbons boiling in the vacuum gas oil fraction (from 350 to 565° C.), as well as other species present in crude oils and heavy cuts of petrochemical products, to access mesoporous active sites.

In embodiments, the zeolite Beta particles of the instant application may have a micropore surface area (“S_{mic}”) and a total surface area (“Sₜₒₜ”) defined by a Brunauer-Emmett-Teller (“BET”) analysis, as is understood by those skilled in the art. In embodiments, the zeolite Beta particles of the instant application may have an S_{mic} of from 10 meters² per gram (“m²/g”) to 800 m²/g, such as from 10 m²/g to 100 m²/g, from 100 m²/g to 250 m²/g, from 250 m²/g to 500 m²/g, or 500 m²/g to 800 m²/g, or any combination of these ranges. In embodiments, the zeolite Beta particles of the instant application may have an Sₜₒₜ of from 100 m²/g to 1800 m²/g, such as from 100 m²/g to 500 m²/g, from 500 m²/g to 1000 m²/g, from 1000 m²/g to 1500 m²/g, or from 1500 m²/g to 1800 m²/g, or any combination of these ranges. In embodiments, the zeolite Beta particles of the instant application may have an Sₜₒₜ that is at least 10% greater, at least 15% greater at least 20% greater, or at least 25% greater than the Sₜₒₜ of the parent zeolite.

In one or more embodiments, the zeolite Beta particles described herein may have a micropore volume (“V_{mic}”), defined using a t-plot method, and a total pore volume (“Vₜₒₜ”) defined by BET analysis, as is understood by those skilled in the art. In one or more embodiments, the zeolite Beta particles described herein may have a V_{mic} of from 0.05 to 0.50 cubic centimeters per gram (“cm³/g”), such as from 0.05 cm³/g to 0.10 cm³/g, from 0.10 cm³/g to 0.20 cm³/g, from 0.20 cm³/g to 0.30 cm³/g, from 0.30 cm³/g to 0.40 cm³/g, or from 0.40 cm³/g to 0.50 cm³/g. In embodiments, the zeolite Beta particles may have a Vₜₒₜ of from 0.01 cm³/g to 1.5 cm³/g, such as from 0.01 cm³/g to 0.25 cm³/g, from 0.25 cm³/g to 0.5 cm³/g, from 0.5 cm³/g to 0.75 cm³/g, from 0.75 cm³/g to 1 cm³/g, from 1 cm³/g to 1.25 cm³/g, from 1.25 cm³/g to 1.5 cm³/g, or any combination of these ranges. In embodiments, the zeolite Beta particles of the instant application may have an Vₜₒₜ that is at least 50% greater, at least 100% greater, at least 125% greater, at least 150% greater, at least 175% greater, or at least 200% greater than the Vₜₒₜ of the parent zeolite.

A mesopore size distribution can be calculated by applying density functional theory (“DFT”) to the adsorption branch of an N₂ isotherm using Micromeritics-Microactive software, as is understood by those skilled in the art. In embodiments of the zeolite Beta particles disclosed herein, the average mesopore size of the radially arranged mesopores may be from 2 nm to 50 nm, such as from 2.5 nm to 15 nm, from 5 nm to 10 nm, or from 7 nm to 8 nm. In embodiments, the branches and sub-branches of mesopores that interconnect the radially arranged mesopores may have an average mesopore size distribution that also ranges from 2 nm to 50 nm, but may be different than the average mesopore size of the radially arranged mesopores. In embodiments, the branches and sub-branches of mesopores that interconnect the radially arranged mesopores may have an average mesopore size distribution that is smaller than the average mesopore size of the radially arranged mesopores.

Also presently disclosed are methods of making the zeolite Beta particles described herein. The zeolite Beta particles may be synthesized via a base-mediated dissolving of a “parent” zeolite Beta into multiple oligomeric units, followed by a surfactant-mediated re-assembly of the oligomeric units. The dissolving and re-assembly steps are controlled to minimize or avoid the amorphization of the parent zeolite. The methods disclosed herein produce zeolite Beta particles with a plurality of radially arranged mesopores.

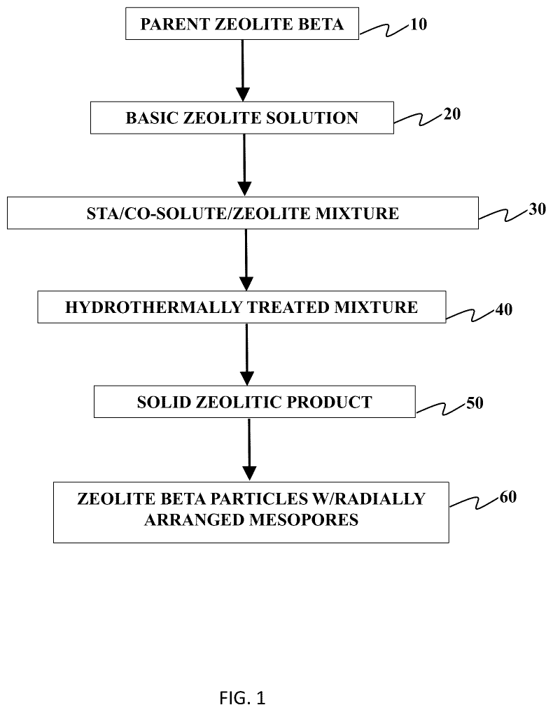

FIG. 1 depicts one path for producing the zeolites presently disclosed. However, other suitable methods may be utilized, in including those yet to be discovered, for producing the zeolite Beta particles presently disclosed having radially arranged mesopores as described herein. Referring now to FIG. 1, the synthetic methods disclosed herein may comprise dissolving a preformed “parent” zeolite Beta 10 in a basic solution, while heating, stirring, or both, to yield a basic zeolite solution 20. In embodiments, the preformed parent zeolite may comprise a *BEA microporous framework. In embodiments, the dissolving the preformed parent zeolite in a basic solution may result in desilication. In embodiments, the dissolving the preformed parent zeolite in a basic solution may result in the preformed parent zeolite being degraded into multiple oligomeric units.

According to the methods herein, while heating, stirring, or both, a supramolecular templating agent (“STA”) and an ionic co-solute may be added to the basic zeolite solution to produce an STA/co-solute/zeolite mixture 30. The STA/co-solute/zeolite mixture 30 may be subjected to hydrothermal treatment for a duration of time to give a hydrothermally treated mixture 40. A solid zeolitic product 50 comprising radially arranged mesopores may be separated from the hydrothermally treated mixture 40 and washed. Optionally at this stage, the solid zeolitic product 50 may be dried. In embodiments, the mesopores of solid zeolitic product 50 may comprise the STA. The STA may be removed from solid zeolitic product 50 to produce zeolite Beta particles 60 comprising mesopores in a center-radial configuration.

In embodiments, the basic zeolite solution 20 may comprise a basic reagent. In embodiments, the basic reagent may comprise one or more basic compounds to maintain the basic zeolite solution 20 at a pH level of greater than about 8. In embodiments, prior to dissolving the parent zeolite Beta 10, the concentration of the basic reagent in the basic solution may be from about 0.1 moles per liter (“M”) to about 2.0 M. In certain embodiments the basic reagent may be provided at a concentration of about 0.1 weight percent (wt %) to 5 wt %. In embodiments, the basic reagent may comprise urea, ammonium hydroxide, or alkali metal hydroxides.

In some embodiments, the rate and extent of the dissolving of the parent zeolite Beta 10 is controlled by employing urea as an in situ base precursor, which may produce ammonium hydroxide which is a base. Urea may also be comprises in the basic solution. In such embodiments, a high concentration of urea can be used in the initial step. The urea, which is pH-neutral at ambient conditions, can disperse uniformly throughout the zeolitic micropores without dissolving the parent zeolite Beta 10. Over time, urea is gradually hydrolyzed to ammonium hydroxide and the pH of the basic zeolite solution 20 slowly increases, allowing for a controlled dissolution of the parent zeolite Beta 10.

In embodiments of the disclosed methods, prior to the addition of the STA and ionic co-solute, the basic zeolite solution 20 may be agitated, such as by stirring, for a duration of from 0.1 minutes to 60 minutes. In embodiments, prior to the addition of the STA and ionic co-solute, the basic zeolite solution 20 may be agitated at a temperature from 20° C. to 80° C.

In embodiments, the STA/co-solute/zeolite mixture 30 may comprise an STA in a concentration of from about 0.01 M to about 0.5 M. In embodiments, the STA may comprise a surfactant comprising a functionalized head group and a functionalized tail group. In such embodiments, at least one dimension of the functionalized head group or the functionalized tail group of the surfactant may be larger than the diameter of the micropores of the parent zeolite Beta 10. In embodiments, at least one dimension of the functionalized head group or the functionalized tail group of the surfactant may limit the diffusion of the supramolecular templating agent into the micropores of the parent zeolite Beta 10.

In embodiments, the STA may comprise at least one cation, such as an alkylammonium cation. In embodiments, a cation of the STA may be paired with an anion, such as Cl⁻, Br⁻, I⁻, or OH⁻. In embodiments, the STA may comprise dioctadecyldimethylammonium chloride or derivatives of thereof.

In embodiments, the ionic co-solute may comprise nitrate (NO₃⁻) in the form of a nitrate salt. In such embodiments, the nitrate salt may comprise ammonium nitrate or a metal nitrate, wherein the metal can be an alkali metal, an alkaline earth metal, a transition metal, a noble metal, or a rare earth metal. In embodiments, the ionic co-solute may comprise sodium nitrate.

According to the methods described herein, the STA/co-solute/zeolite mixture 30 may be subjected to hydrothermal treatment for a duration of from 4 hours (“h”) to 168 h. In embodiments, the STA/co-solute/zeolite mixture 30 may be subjected to hydrothermal treatment at a temperature of from about 70° C. to about 250° C. In some embodiments, the solid zeolitic product 50 may be washed with water after being removed from the hydrothermally treated mixture 40. In some embodiments, the solid zeolitic product 50 may be dried at a temperature from 100° C. to 200° C. for a duration of from 1 h to 48 h.

In embodiments of the methods of the instant disclosure, the solid zeolitic product 50 may comprise a plurality of micropores and a plurality of radially arranged mesopores, wherein the mesopores comprise the STA. According to embodiments of the methods herein, the STA may be removed from the mesopores of the solid zeolitic product 50 to produce zeolite Beta particles with radially arranged mesopores 60.

In embodiments, the STA may be removed from the solid zeolitic product 50 by various chemical or physical methods, such as calcination, solvent extraction, chemical oxidation, ionic liquid treatment, treatment with supercritical CO₂, microwave-assisted treatment, ultrasonic assisted treatment, ozone treatment, and plasma technology. In embodiments, the preferred method of removing the STA is calcination.

### EXAMPLES

The various embodiments of methods described will be further clarified by the following examples. The examples are illustrative in nature, and should not be to limit the subject matter of the present disclosure.

Micropore surface area (S_{mic}), total surface area (Sₜₒₜ), and total pore volume (Vₜₒₜ) were determined with the Brunauer-Emmett-Teller (BET) method in the P/P₀ range from 0.1 to 0.3. The t-plot method was used to estimate the micropore volume (V_{mic}). Nitrogen physisorption measurements were performed at −196° C. on a Micromeritics ASAP 2420 porosimeter. The mesopore size distribution (D) was obtained using a DFT model applied to the adsorption branch of the N₂ physisorption isotherm.

X-ray diffraction (XRD) measurements were taken using a Bruker D8-Twin diffractometer having Cu Kα radiation (λ=0.154 nm) detector. Data was recorded in the range of from 0.5 to 50 2θ/degrees. The voltage and current were 40 kV and 40 mA, respectively, and the scanning rate was 0.5 degree min⁻¹.

Transmission electron microscopy (TEM) imaging was performed using an FEI Titan-ST Transmission Electron Microscope using an operating voltage of 300 kV.

### Example 1—Radial Mesopore Embodiment

Initially, 1.0 g of urea was dissolved in 10.0 g of water to form a homogeneous solution. To this solution, 1.0 g of dried zeolite Beta CP-811T-100 (SiO₂:Al₂O₃≈100 (mol:mol)) was added and stirred for 0.5 h. Subsequently, 20 mL of water, 0.1 g of NH₄NO₃, and 2.0 mL of dioctadecyldimethylammonium chloride (42.0 wt % in methanol) were added stepwise. The mixture was stirred for 2 h at room temperature. The resultant solution was hydrothermally treated at 170° C. for three days. The resulting solids were filtered, washed with water, and dried at 120° C. for 24 h. The dried solids were calcined in air at 550° C. for 6 h at a ramp rate of 60° C. h⁻¹ to yield zeolite Beta particles with mesopores arranged in a center-radial configuration. FIG. 2A and 2B depict microscopic images of this example, which show the mesopores in a center-radial configuration.

### Comparative Example 2—Non-Radial Mesopores Embodiment

Initially, 1.0 g of urea was dissolved in 10.0 g of water to form a homogeneous solution. To this mixture, 1.0 g of dried zeolite CP-814C (SiO₂:Al₂O₃≈300) was added and stirred for 0.5 h. Subsequently, 20 ml of water, 0.1 g of NH₄NO₃, and 2.0 mL of DOAC (42.0 wt % in methanol) were added stepwise. The mixture was stirred for 2 h at room temperature. The mixture was further stirred for 2 h at RT. The resultant solution was hydrothermally treated at 150° C. for 3 days. The resulting solids were filtered, washed with water, and dried at 120° C. for 24 h. The synthesized products were calcined in air at 550° C. for 6 h at a ramp rate of 60° C. h⁻¹ to yield zeolite Beta particles with cubically-arranged mesopores. FIG. 3 depicts a microscopic image of this sample, which show the beta zeolite with long-range mesoporous order having cubic symmetry but not possessing radially arranged mesopores.

### Comparative Example 3—No Mesopore Embodiment

Comparative Example 3 comprises a conventional, commercially available zeolite Beta (SiO₂:Al₂O₃≈100 (mol:mol)) with no mesopores (CP-811T commercially available from Zeolyst). FIGS. 4A-4C depict microscopic images of this sample.

### Example 4—Characterization of Samples

The TEM images of the inventive and comparative zeolite Beta particles are shown in FIGS. 2-4. FIG. 2A shows a TEM image of a plurality of the inventive zeolite Beta particles Example 1 (“E1”), which reveals that particles have a cuboid-type morphology with particle size ranging from 200 to 500 nm. FIG. 2B shows a TEM image of a single inventive zeolite Beta particle E1, which reveals an open type mesostructure with the radial mesopores organized from the core of the particle to the periphery. For comparison, FIG. 3 depicts a TEM micrograph of mesoporous zeolite Beta Comparative Example 2 (“CE2”), in which the mesopores have long-range order having cubic symmetry, rather than in a center-radial configuration. FIGS. 4A-4C depict TEM images of Comparative Example 3 (“CE3”), which does not comprise any mesopores.

The TEM data of E1 indicate that the radial mesopores are interconnected by branches and sub-branches of mesopores and zeolitic micropores forming a three-dimensional hierarchical reticular network. The radially arranged mesopores have a wide range of dimensions ranging from 3 to 15 nm, whereas the interconnecting mesoporous and microporous branches are relatively smaller. The inset in FIG. 4B shows the lattice fringes corresponding to the BEA-type.

The structural and textural properties of E1 and CE3 are summarized in Table 1.

TABLE 1

| | E1 | CE3 |
|---|---|---|
| Composition | zeolite Beta with | zeolite Beta with |
| | radial mesopores | no mesopores |
| S_{mic} (m² g⁻¹) | 431 | 459 |
| Sₜₒₜ (m²g⁻¹) | 714 | 623 |
| D (nm) | 7.5 | — |
| V_{mic} (cm³g⁻¹) | 0.17 | 0.18 |
| Vₜₒₜ (cm³g⁻¹) | 0.54 | 0.25 |

The data in Table 1 indicates that the inventive zeolite Beta particles disclosed herein have a higher total surface area (714 m²/g for E1) than the conventional zeolite Beta particles (623 m²/g for CE3). The inventive zeolite Beta particles also have a higher total pore volume (0.54 cm³/g for E1) than the conventional zeolite Beta particles (0.25 cm³/g for CE3). Because the microporous surface area and the microporous volume of E1 are both approximate to or lower than the microporous surface area and the microporous volume of CE3, it follows that the increase in total surface area and total pore volume is due to the presence of the mesopores in the inventive zeolite Beta particles.

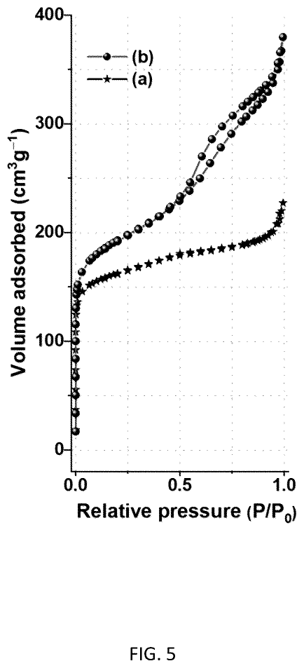

FIG. 5 shows the N₂ physisorption isotherms for E1 (b) and CE3 (a). Evaluation of the adsorption and desorption branches of these isotherms and the hysteresis between them reveals that the mesoporous zeolite Beta possess a type-IV isotherm with broad hysteresis ranging over from 0.45 to 0.9 P/P₀, indicating the presence of mesopores of different dimensions. The presence of mesopores is further reflected in the broad pore-size distributions obtained from the DFT method. In addition, the high N₂ adsorption below 0.1 P/P₀ suggests that the prepared structure also possesses high amount of microporosity. In contrast, CE3 generates a type-I isotherm, which indicates a microporous structure without mesopores.

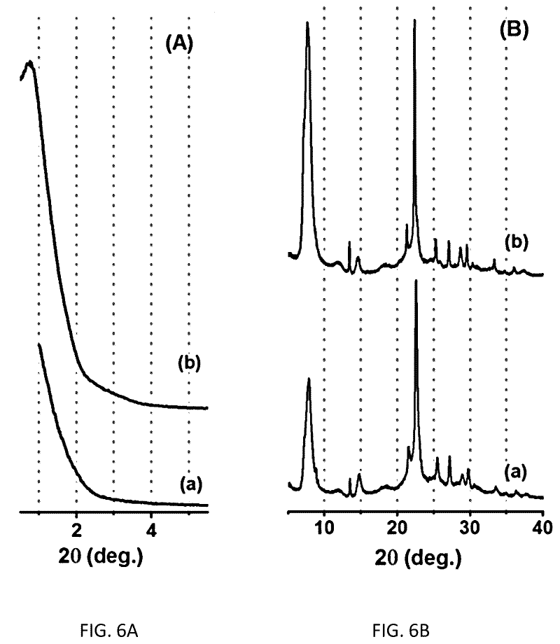

FIGS. 6A and 6B show the low angle (6A) and high angle (6B) XRD patterns for the inventive zeolite Beta particles, E1 (b), and the commercially available CE3 (a). In contrast to the CE3, the XRD pattern of inventive zeolite E1 shows a broad reflection in the low-angle region, which suggests that the mesopores are organized uniformly amidst the crystal domain without any specific order. The high angle XRD patterns of the mesoporous zeolite beta is analogous to the parent zeolite beta without any amorphous phases and impurities suggesting that the zeolite structure is retained during the post-synthetic modification process.

The present disclosure includes one or more non-limiting aspects.

A first aspect includes a zeolite Beta particle including a Beta zeolitic framework including a plurality of micropores having diameters of less than or equal to 2 nm, the Beta zeolitic framework including alumina and silica, and a plurality of mesopores having diameters of greater than 2 nm and less than or equal to 50 nm, wherein the plurality of mesopores are arranged in a center-radial configuration, such that mesopores run from a central region of the zeolite Beta particle towards the edge of the zeolite Beta particle.

A second aspect includes any above aspect or combination of above aspects, wherein a total surface area of the zeolite Beta particle is from 500 m²/g to 1500 m²/g.

A third aspect includes any above aspect or combination of above aspects, wherein a microporous surface area of the zeolite Beta particles is from 250 m²/g to 750 m²/g.

A fourth aspect includes the any above aspect or combination of above aspects, wherein a micropore volume of the zeolite Beta particle is from 0.10 cm³/g to 0.25 cm³/g.

A fifth aspect includes any above aspect or combination of above aspects, wherein a total pore volume of the zeolite Beta particle is from 0.25 cm³/g to 1.0 cm³/g.

A sixth aspect includes any above aspect or combination of above aspects, wherein a molar ratio of silica-to-alumina is from 10 to 500.

A seventh aspect includes a method of converting a chemical, the method comprising contacting a reactant with the zeolite Beta particle of any of the above aspects.

An eighth aspect includes the seventh aspect, wherein the reactant is a hydrocarbon.

A ninth aspect includes a method of making a zeolite Beta particle including a plurality of mesopores arranged in a center-radial configuration, the method including: dissolving a parent zeolite in a basic solution to yield a basic zeolite solution, wherein the parent zeolite comprises micropores defined by a *BEA microporous framework; adding to the basic zeolite solution a supramolecular templating agent and an ionic co-solute to form a supramolecular templating agent/co-solute/zeolite mixture; hydrothermally treating the supramolecular templating agent/co-solute/zeolite mixture for a duration of time to form a hydrothermally treated supramolecular templating agent/co-solute/zeolite mixture; separating a solid zeolitic product from the hydrothermally treated supramolecular templating agent/co-solute/zeolite mixture, wherein the solid zeolitic product includes a plurality of mesopores arranged in a center-radial configuration and wherein the plurality of mesopores include the supramolecular templating agent; and removing the supramolecular templating agent from the solid zeolitic product to yield a zeolite Beta particle including mesopores arranged in a center-radial configuration.

A tenth aspect includes the ninth aspect, further including washing the solid zeolitic product after separating the solid zeolitic product from the hydrothermally treated supramolecular templating agent/co-solute/zeolite mixture.

An eleventh aspect includes the tenth aspect, further comprising drying the solid zeolitic product prior to removing the supramolecular templating agent.

A twelfth aspect includes the ninth aspect, wherein removing the supramolecular templating agent includes calcining the solid zeolitic product.

A thirteenth aspect includes any one of or any combination of the ninth through eleventh aspects, wherein the basic solution comprises urea.

A fourteenth aspect includes any one of or any combination of the ninth through twelfth aspects, wherein the supramolecular templating agent includes a surfactant comprising a functionalized head group and a functionalized tail group, wherein: at least one dimension of the functionalized head group or the functionalized tail group is larger than the diameter of the zeolite micropores; and at least one dimension of the functionalized head group or the functionalized tail group limits the diffusion of the supramolecular templating agent into the zeolite micropores.

A fifteenth aspect includes any one of or any combination of the ninth through thirteenth aspects, wherein the supramolecular templating agent includes dioctadecyldimethylammonium chloride.

A sixteenth aspect includes any one of or any combination of the ninth through fifteenth aspects, wherein the ionic co-solute comprises a nitrate salt, and wherein the metal is an alkali metal, an alkaline earth metal, a transition metal, a noble metal, or a rare earth metal.

A seventeenth aspect includes any one of or any combination of the night through sixteenth aspects, wherein the Sₜₒₜ of the zeolite Beta particle is at least 10% greater than the Sₜₒₜ of the parent zeolite.

A eighteenth aspect includes any one of or any combination of the night through seventeenth aspects, wherein the Vₜₒₜ of the zeolite Beta particle is at least 50% greater than the Vₜₒₜ of the parent zeolite.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A zeolite Beta particle comprising:
a Beta zeolitic framework comprising a plurality of micropores having diameters of less than or equal to 2 nm, the Beta zeolitic framework comprising alumina and silica; and
a plurality of mesopores having diameters of greater than 2 nm and less than or equal to 50 nm, wherein the plurality of mesopores are arranged in a center-radial configuration, such that mesopores run from a central region of the zeolite Beta particle towards the edge of the zeolite Beta particle.

2. The zeolite Beta particle of claim 1, wherein a total surface area of the zeolite Beta is from 500 m²/g to 1500 m²/g.

3. The zeolite Beta particle of claim 1, wherein a microporous surface area of the zeolite Beta is from 250 m²/g to 750 m²/g.

4. The zeolite Beta particle of claim 1, wherein a micropore volume of the zeolite Beta is from 0.10 cm³/g to 0.25 cm³/g.

5. The zeolite Beta particle of claim 1, wherein a total pore volume of the zeolite Beta is from 0.25 cm³/g to 1.0 cm³/g.

6. The zeolite Beta particle of claim 1, wherein a molar ratio of silica-to-alumina is from 10 to 500.

7. A method of converting a chemical, the method comprising contacting a reactant with the zeolite Beta particle of claim 1.

8. The method of claim 7, wherein the reactant is a hydrocarbon.

9. A method of making a zeolite Beta particle comprising a plurality of mesopores arranged in a center-radial configuration, the method comprising:
dissolving a parent zeolite in a basic solution to yield a basic zeolite solution, wherein the parent zeolite comprises micropores defined by a *BEA microporous framework;
adding to the basic zeolite solution a supramolecular templating agent and an ionic co-solute to form a supramolecular templating agent/co-solute/zeolite mixture;
hydrothermally treating the supramolecular templating agent/co-solute/zeolite mixture for a duration of time to form a hydrothermally treated supramolecular templating agent/co-solute/zeolite mixture;
separating a solid zeolitic product from the hydrothermally treated supramolecular templating agent/co-solute/zeolite mixture, wherein the solid zeolitic product comprises a plurality of mesopores arranged in a center-radial configuration and wherein the plurality of mesopores comprise the supramolecular templating agent; and
removing the supramolecular templating agent from the solid zeolitic product to yield a zeolite Beta particle comprising a plurality of mesopores arranged in a center-radial configuration.

10. The method of claim 9, further comprising washing the solid zeolitic product after separating the solid zeolitic product from the hydrothermally treated supramolecular templating agent/co-solute/zeolite mixture.

11. The method of claim 10, further comprising drying the solid zeolitic product prior to removing the supramolecular templating agent.

12. The method of claim 9, wherein removing the supramolecular templating agent comprises calcining the solid zeolitic product.

13. The method of claim 9, wherein the basic solution comprises ammonium hydroxide formed from urea.

14. The method of claim 9, wherein the supramolecular templating agent comprises a surfactant comprising a functionalized head group and a functionalized tail group, wherein
at least one dimension of the functionalized head group or the functionalized tail group is larger than the diameter of the zeolite micropores; and
at least one dimension of the functionalized head group or the functionalized tail group limits the diffusion of the supramolecular templating agent into the zeolite micropores.

15. The method of claim 9, wherein the supramolecular templating agent comprises dioctadecyldimethylammonium chloride.

16. The method of claim 9, wherein the ionic co-solute comprises a nitrate salt, and wherein the metal is an alkali metal, an alkaline earth metal, a transition metal, a noble metal, or a rare earth metal.

17. The method of claim 9, wherein the Sₜₒₜ of the zeolite Beta particle is at least 10% greater than the Sₜₒₜ of the parent zeolite.

18. The method of claim 9, wherein the Vₜₒₜ of the zeolite Beta particle is at least 50% greater than the Vₜₒₜ of the parent zeolite.
